(19) United States
(12) Patent Application Publication
(10) Pub. No.: US 2006/0291395 A1
(43) Pub. Date: Dec. 28, 2006

(54) Packet transmission control method and apparatus

(75) Inventors: Timo Ketonen, Helsinki (FI); Petri To. Mattila, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/269,814

(22) Filed: Nov. 9, 2005

(30) Foreign Application Priority Data
Jun. 28, 2005 (EP) 05 013 976.5

(51) Int. Cl. H04L 12/26

(52) U.S. Cl. 370/236

(57) ABSTRACT

A packet transmission control method and apparatus for packet transmissions between a transmitting side and a receiving side in a mobile communication system, wherein packets transmitted by the transmitting side are acknowledged by the receiving side, and unacknowledged packets are retransmitted to the receiving side, the method comprising at least one of the steps of: scheduling of packets, wherein packets not yet acknowledged are retransmitted only when no packets not yet transmitted to the receiving side are available at the transmitting side, and polling the receiving side to acknowledge transmitted packets on the basis of a packet counter value and a timer value.

### FIELD OF THE INVENTION

The present invention relates to a packet transmission control method and apparatus for packet transmissions between a transmitting side and a receiving side in a mobile communication system. In particular, the present invention relates to scheduling and polling in (enhanced) general packet radio systems.

### BACKGROUND OF THE INVENTION

In recent years, communication technology has widely spread in terms of number of users and amount of use of the telecommunication services by the users. This also led to an increase in the number of different technologies and technological concepts in use.

A main aspect in the area of mobile communications is the development of mobile communication systems of the third and fourth generation. In this regard, general packet radio service (GPRS) and enhanced general packet radio service (EGPRS) can be mentioned as an example. These communication systems are usually packet data networks in which data transmission is organized on a packet basis.

Transmission protocols used are typically arranged in such a manner that data to be transferred is segmented into a sequence of packets, often referred to as Packet Data Units (PDUs), which are then individually transferred to a destination or receiving side where they are reassembled by the transmission protocol.

To achieve a reliable packet transmission, the transmission protocol has to assure that all transmitted packets are received correctly by the receiving side. For this purpose, the receiving side sends acknowledgements to the transmitting side which in turn retransmits unacknowledged packets, i.e. packets not being received at all or not being successfully received at the receiving side. In some cases, the transmitting side explicitly commands the receiving side to send an acknowledgement for one or more transferred packets. Such a procedure is known as polling.

The retransmission of packets not yet acknowledged, i.e. so-called pending-ack packets, is performed according to a specific ARQ (Automatic Repeat ReQuest) scheme. Examples for widely used ARQ schemes include a Go-Back-N method and a Selective Retransmission ARQ method.

The Selective Retransmission ARQ method is based on the sequence numbers of the transmitted packets. Thereby, it is possible to achieve a high efficiency on the radio channel since the packets requiring a retransmission are uniquely identified by their sequence numbers, and no more packets than needed are retransmitted. This method is often used with a so-called sliding window technique according to which only those packets having sequence numbers within a specific transmit window are transmitted or retransmitted. The receiving side maintains a corresponding receive window and accepts only those packets having sequence numbers within the receive window. The respective transmit and receive windows are adapted whenever a packet transmission including an acknowledgement is successfully completed.

A known polling method using the sliding window technique is known from the PCT patent application WO-01/22645. The thus disclosed error control method performs a control so as to allow a transmission of data units in dependence on the sequence number of a preceding data unit not yet acknowledged. In this method, the transmission rate of acknowledged messages, and thereby the number of packets transmitted between successive acknowledgements, is changed in response to an estimated transmission quality of a transmission channel.

The method according to document WO-01/22645 is also applicable in connection with real time traffic such as audio and/or video applications, for example. Such real time traffic is inter alia characterized by low delay requirements. The presented polling algorithm is based on a packet counter, and polling is performed when some predefined packet counter value is reached. Especially for low volume traffic, i.e. traffic with a low guaranteed bit rate, this method yields quite sparse polling. Thus, the information of correctly received packets or blocks may be delayed.

As a further aspect in mobile communication systems besides ensuring reliable packet transmission there is to be mentioned scheduling of available radio resources on a wireless transmission path. Such scheduling usually relates to scheduling of a multitude of user connections (i.e. signaling and traffic channels) and/or traffic flows on a single physical medium available.

An old, simple and fair scheduling algorithm designed especially for time-sharing systems is called round-robin (RR) scheduling. This common mechanism is known to a person skilled in the art, and therefore will not be explained in further detail hereinafter.

For radio resource scheduling in mobile communication systems there have been introduced some variations of round-robin scheduling, among which weighted round-robin (WRR) and deficient round-robin (DRR) are mentioned here as an example.

The US patent application U.S. Pat. No. 2004120258 is directed to traffic channel scheduling of a plurality of input flows to a single output flow in a mobile communication environment. An important aspect of implementing this method is a deficit level of a data flow, wherein the content of a so-called “bucket” represents the deficit level. The thus disclosed method is hence called bucket round-robin (BRR) scheduling algorithm.

The BRR algorithm performs scheduling in two phases. In a first phase, bandwidth is shared for a guaranteed bit rate. In a second phase, the residual bandwidth is shared. For internal handling there is defined a priority level, and scheduling is performed in a strict priority order between given priority bounds. In this algorithm, it may occur under certain circumstances that a transmission turn must be left unused, and a dummy or an idle block is sent.

In known prior art solutions, retransmissions of pending-ack blocks is prioritized below new transmissions and mere data block retransmissions. Depending on the case, this may include all or some parts of the pending-ack blocks.

In view of the above, a solution to the above problems and drawbacks is needed for the evolution of quality of service (QoS) in GSM (Global System for Mobile communication) and/or (E)GPRS systems.

### SUMMARY OF THE INVENTION

Consequently, it is an object of the present invention to remove or alleviate at least one of the above drawbacks inherent to the prior art, and to provide an improved method and apparatus.

According to a first aspect of the invention, this object is for example achieved by a packet transmission control method for packet transmissions between a transmitting side and a receiving side in a mobile communication system, wherein packets transmitted by the transmitting side are acknowledged by the receiving side, and unacknowledged packets are retransmitted to the receiving side, the method comprising at least one of the steps of: scheduling of packets, wherein packets not yet acknowledged are retransmitted only when no packets not yet transmitted to the receiving side are available at the transmitting side, and polling the receiving side to acknowledge transmitted packets on the basis of a packet counter value and a timer value.

According to further advantageous developments:
the step of scheduling further comprises a step of allocating one of a plurality of priority levels to each packet, wherein packets not yet acknowledged are allocated lower priority levels than packets not yet transmitted;
the step of scheduling further comprises the steps of scheduling of packets not yet transmitted; and scheduling of packets not yet acknowledged, wherein the step of scheduling of packets not yet transmitted is based on the priority levels allocated to these packets, the packets with higher priority levels being scheduled to be transmitted prior to the packets with lower priority levels;
the step of scheduling of packets not yet acknowledged is performed when the step of scheduling of packets not yet transmitted is completed;
the step of scheduling of packets not yet transmitted is performed on the basis of a bucket round robin scheme;
the step of scheduling of packets not yet acknowledged is performed on the basis of a round robin scheme;
the step of polling is performed when a predefined packet counter value or a predefined timer value is reached;
the packet counter value is changed by a predetermined value when a packet is transmitted;
the packet counter value and the timer value are reset to a predefined initial value when the step of polling is performed;
the predefined timer value is fixed;
the predefined timer value is dependent on at least one quality of service parameter being associated with the packets to be transmitted;
the step of polling is performed only for real time packets; and
the packets to be transmitted belong to a temporary block flow of a packet flow context.

According to a second aspect of the invention, this object is for example achieved by an apparatus for controlling packet transmissions between a transmitting side and a receiving side in a mobile communication system, wherein packets transmitted by the transmitting side are acknowledged by the receiving side, and unacknowledged packets are retransmitted to the receiving side, the apparatus comprising at least one of: a packet scheduling device for scheduling of packets, wherein the packet scheduling device is configured such that packets not yet acknowledged are retransmitted only when no packets not yet transmitted to the receiving side are available at the transmitting side; and a polling device for polling acknowledgements for packet transmissions, wherein the polling device is configured for polling the receiving side to acknowledge transmitted packets on the basis of a packet counter value and a timer value.

According to further advantageous developments:
the packet scheduling device comprises: priority allocating means for allocating one of a plurality of priority levels to each packet, wherein the priority allocating means is configured for allocating to packets not yet acknowledged lower priority levels than to packets not yet transmitted;
the packet scheduling device further comprises: first scheduling means for scheduling of packets not yet transmitted; and second scheduling means for scheduling of packets not yet acknowledged, wherein the first scheduling means is configured to operate based on the priority levels allocated to these packets such that the packets with higher priority levels are scheduled to be transmitted prior to the packets with lower priority levels;
the second scheduling means is configured to perform scheduling when the first scheduling means has completed scheduling of packets not yet transmitted;
the first scheduling means is configured to operate on the basis of a bucket round robin scheme;
the second scheduling means is configured to operate on the basis of a round robin scheme;
the packet scheduling device is a radio link control scheduler;
the polling device is configured for performing polling when a predefined packet counter value or a predefined timer value is reached;
the polling device comprises control means having a packet counter and a timer, wherein the control means is configured for maintaining the packet counter value and the timer value;
the control means is configured to change the packet counter value by a predetermined value when a packet is transmitted;
the control means is configured to reset the packet counter value and the timer value to a predefined initial value when polling is performed;
the polling device is configured for performing polling only for real time packets;
the apparatus further comprises transceiver means for performing transmission and reception between the transmitting side and the receiving side;
the transceiver means is configured for transmitting packets not yet transmitted to the receiving side and for retransmitting packets not yet acknowledged to the receiving side, wherein the packets are obtained from the packet scheduling device;
the transceiver means is configured for transmitting polling requests from the polling device to the receiving side, and for receiving acknowledgments from the receiving side and forwarding these to the polling device;
the packets to be transmitted belong to a temporary block flow of a packet flow context;
the apparatus forms a part of a packet control unit;
the apparatus forms a part of a terminal equipment;
the mobile communication system is a general packet radio service (GPRS) system;
the mobile communication system is an enhanced general packet radio service (EGPRS) system; and
the mobile communication system is a global system for mobile communication (GSM) system.

It is an advantage of the present invention that a capacity loss due to unnecessary retransmissions of pending-ack blocks is avoided.

It is a further advantage that the proposed method is suitable for real time traffic which may be used for many applications in mobile communication systems. The present invention is able to comply with low delay requirements. Thereby, a favorable low delay effect of the necessary retransmissions is advantageously achieved.

It is another advantage of the present invention that no transmission turn must be left unused. Thereby, the present invention increases radio resource efficiency with fewer wasted transmitting permissions, leads to lower delays in data retransmission, and reduces jitter in polling.

It is still another advantage of the present invention that it is not necessary to actively avoid high load and/or overload situations in order to obtain favorable results. Accordingly, an erratic behavior in high load and/or overload conditions can be avoided, and no admission control is required for obviating them.

Namely, the proposed scheduling in high load or even overload conditions does not serve the highest priority context in a mere round-robin fashion, which leads to the following benefits of the proposed solution according to the present invention.

According to the present invention, there does no configuration in which radio link control (RLC) blocks not yet acknowledged, i.e. so-called pending-ack blocks, are scheduled even though some other data flows such as temporary block flows (TBFs) may have new data available to be transmitted. Such a configuration is also excluded for a high load condition with more than two TBFs per time slot, where the incoming data flows are bursty in nature and have pauses in data transmission. It is obviated that, during such pauses, the logical link control (LLC) buffers in a packet control unit PCU run empty and pending-ack blocks requiring retransmissions are scheduled unoptimally.

Therewith, the bit rates achieved are better than with previously used scheduling algorithms. Furthermore, it is appreciated that the pending-ack retransmissions help real time packet flow contexts PFCs to meet their low delay guarantee. By virtue of the present invention, the real time PFCs such as streaming PFCs meet their bit rate and delay guarantees without wasting radio time for pending-ack retransmissions.

Hence, an erratic behavior observed in prior art solution is avoided, according to which the LLC data buffers run empty recurrently in high load scenarios, without the temporary block flows being torn down. This would happen with both real time (RT) and non real time (nRT) traffic, but with different mechanisms.

With RT traffic, the problem avoided by the present invention would arise when the streaming LLC buffers run empty, without meeting the overall PFC bit rate requirement. Then pending-ack blocks would be scheduled in the first BRR scheduling phase from the streaming packet flow context instead of new data from the other packet flow contexts.

With nRT traffic, the same problem would happen also in the second scheduling phase due to improper selection of scheduling parameters.

Although the mentioned problem according to the prior art is not present in normal low load situations, where the average number of temporary block flows per time slot is less than two, the problem arising in high load situations is problematic as regards network capacity and given delay requirements. Thus, the solution thereof according to the present invention is highly advantageous for many applications in mobile communication systems.

Furthermore, there has not been proposed any prior art solution to this problem beforehand. Additionally, the solution presented here also advantageously improves previous solutions to general problems with scheduling of pending-ack blocks. This is based on the fact that the solutions presented previously usually have bad effects on real time and/or streaming packet flow contexts, for which the pending-ack retransmissions have favorable effects on delay.

The above described advantages are achieved by improvements according to the embodiments of the present invention, which improvements are, above all, simple and straightforward to implement and/or to integrate into already implemented systems.

### BRIEF DESCRIPTION OF THE DRAWINGS

In the following, the present invention will be described in greater detail with reference to the accompanying drawings, in which

FIG. 1 depicts a flow diagram of a method according to one embodiment of the present invention; and

FIG. 2 depicts a block diagram of an apparatus according to one embodiment of the present invention.

### DETAILED DESCRIPTION OF EMBODIMENTS OF THE PRESENT INVENTION

The present invention provides, according to the presented embodiments, an evolution of quality of service (QoS) e.g. in GSM/GPRS systems of Release 4 and onwards. The presented solutions provide enhancements to scheduling and polling functions in communication networks. The solutions according to the present invention are suitable to be used for supporting or improving support for real time streaming traffic in base station controllers (BSCs) or similar network elements of other network types. In particular, the present invention features an enhanced quality of service.

The present invention is described herein with reference to certain embodiments thereof. In particular, the present invention is described in relation to an (enhanced) general packet radio service (E)GPRS example implementation. As such, the description of the embodiments given herein specifically refers to terminology which is directly related to (E)GPRS. Such terminology is only used in the context of the presented examples, and does not limit the present invention in any way.

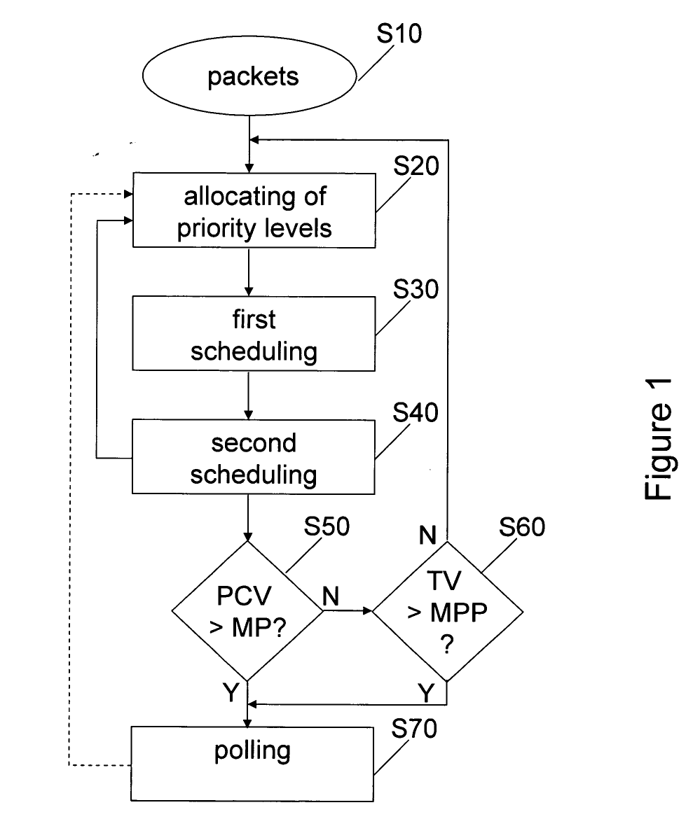

FIG. 1 depicts a flow diagram of a method according to one embodiment of the present invention.

For the sake of clarity and simplicity, the shown example procedure is directed to a processing of packets or blocks belonging to a single data flow or temporary block flow (TBF) of a packet flow context (PFC). Nevertheless, the present invention is also applicable to scenarios of multiple flows, as will be evident to a person skilled in the art. Thus, it should be clear that a number of packets or blocks can always be considered to represent a temporary block flow or the like.

At the beginning of the proposed packet transmission control method, packets are waiting for being processed (step S10). These packets comprise packets, which have not yet been transmitted beforehand, and thus wait for their transmission to be scheduled, and of packets, which have been transmitted beforehand but have not yet been acknowledged by a receiving side, and thus wait for their retransmission to be scheduled.

In step S20, one of a plurality of priority levels is allocated to each of the waiting packets. The allocated priority levels determine the order of processing of the packets, but rules for the allocation will not be described herein in detail. For the present invention, the specific rules for allocation of priority levels to packets may depend on implementation details or requirements. It can, for example, be performed in any suitable manner known in prior art. However, the result of allocation has to be such that packets not yet acknowledged are allocated lower priority levels than packets not yet transmitted.

Next, the packets are subjected to a first step of scheduling (step S30) which is based on the priority levels allocated to the packets. Thereby, the packets with higher priority levels are scheduled to be transmitted prior to packets with lower priority levels. This scheduling may, for example, be in accordance with a bucket round-robin scheme wherein this step would correspond to phases I and II of a BRR algorithm. Since, according to the present embodiments, the packets (or TBFs) needing only a pending-ack retransmission have a lower priority than any other traffic, these packets not yet acknowledged are considered inactive in the first scheduling step. Accordingly, only packets not yet transmitted are scheduled for transmission in this step.

The remaining and still not scheduled packets needing a pending-ack retransmission are then processed in a second step of scheduling being denoted by S40.

The step S40 could be regarded as an additional phase, i.e. a phase III, with respect to the BRR algorithm. According to FIG. 1, step S40 is depicted to be performed when the first step of scheduling is completed. However, as an implementation aspect it is to be noted that the second step of scheduling, i.e. phase III, can also be combined with BRR scheduling phase II for better performance and easier adaptation into already implemented systems. This holds true as long as it is ensured that packets not yet acknowledged are retransmitted only when no packets not yet transmitted to a receiving side are available.

In the second step of scheduling (step S40) the radio resources are shared only for packets not yet acknowledged. Therein, neither a guaranteed bit rate nor the scheduling priorities used in the first step of scheduling, i.e. BRR phases I and II, shall have effect. For example, the scheduling of the packets in this step can be performed on the basis of a round-robin scheme. That is, all blocks or TBFs are handled one by one, one after another.

Such a procedure can for example take account of the fact that there is no knowledge about the reception of the pending-ack blocks available. Thus, there is no reason to favor any of these blocks over the others. Further, the blocks to be retransmitted may contain data from many packet flow contexts (PFCs), so it would be difficult to map the single retransmissions to the individual packet flow contexts (PFCs) and their individual properties.

After one scheduling cycle is completed after step S40, the still remaining packets, i.e. packets which are still not yet acknowledged, are fed back to allocating step S20. As regards a determination of which packets are still not yet acknowledged, reference is made to a step of polling (step S70) described below. At this stage, the still remaining packets and the newly arrived packets are allocated priority levels anew for a new scheduling cycle. In FIG. 1, this is indicated by a feedback line from step S40 back to step S20.

As stated above, the described scheduling strategy according to the present embodiment of the invention prevents sending any pending-ack blocks until all TBFs in a single time slot are in pending-ack state. However, in this connection, there may arise a problem of achieving low delay requirements for real time temporary block flows and their blocks.

According to another facet of the present invention, such low delay requirement are achieved by a step of polling a receiving side to acknowledge transmitted packets. This step of polling according to the present invention is particularly advantageous to alleviate the case where the data volume is low, i.e. with a low guaranteed bit rate.

For this purpose, the polling according to the present invention is based on a packet counter value PCV and on a timer value TV. During successive polls, the packet counter value is changed by a predetermined value when a packet is transmitted, and the timer value represents the elapsed time from a previous poll. The polling is triggered whenever either the packet counter value reaches a predefined value or the timer value reaches a predefined value.

Starting from any earlier poll, a packet counter value is reset and started as well as a timer value. A next poll is performed when the packet counter value PCV exceeds a threshold value Maximum Packets MP, or when the timer value TV exceeds the Maximum Poll Period MPP. In both cases, the timer value and the packet counter value are cleared.

In the simplest form, the Maximum Poll Period can be fixed, and a suggested value for generic streaming traffic can be 250 ms. For more sophisticated systems, a Maximum Poll Period value could be derived from quality of service (QoS) parameters being associated with the individual temporary block flows or packets, such as transfer delay. The actual mapping between one or more QoS parameters and the Maximum Poll Period may depend on implementation concepts or requirements.

In FIG. 1, the test for the polling conditions mentioned above is indicated by steps S50 and S60. Namely, in step 50 it is tested whether the packet counter value has reached its predefined threshold value. If yes, polling is performed in step S70. If no, it is tested in step S60 whether the timer value has reached its predefined threshold value, in which case polling is performed. If neither of the both values triggers a poll, a new scheduling cycle is started instead.

In step S70, a receiving side is polled to acknowledge transmitted packets, and the packet counter value and the timer value are reset to a predefined initial value. The result of polling, i.e. which packets are acknowledged and which packets still remain unacknowledged, is signaled back in order that the following step of allocating priority levels is informed about the status of each packet. In FIG. 1, this signaling is indicated by a broken feedback line from step S70 to step S20.

According to the present invention, it is particularly advantageous to perform the polling only for real time temporary block flows or blocks. This has the advantage that the real time requirements can more easily be fulfilled.

From a point of view of implementation with multiple packet flow contexts (PFCs) the following applies. In BRR scheduling phase II, a first packet flow context is selected from the PFC list, whose temporary block flow (TBF) is in pending-ack state. If the original phase II cannot select any PFC, then the pending-ack candidate is selected. This provides the functionality as explained with scheduling phase III mentioned above.

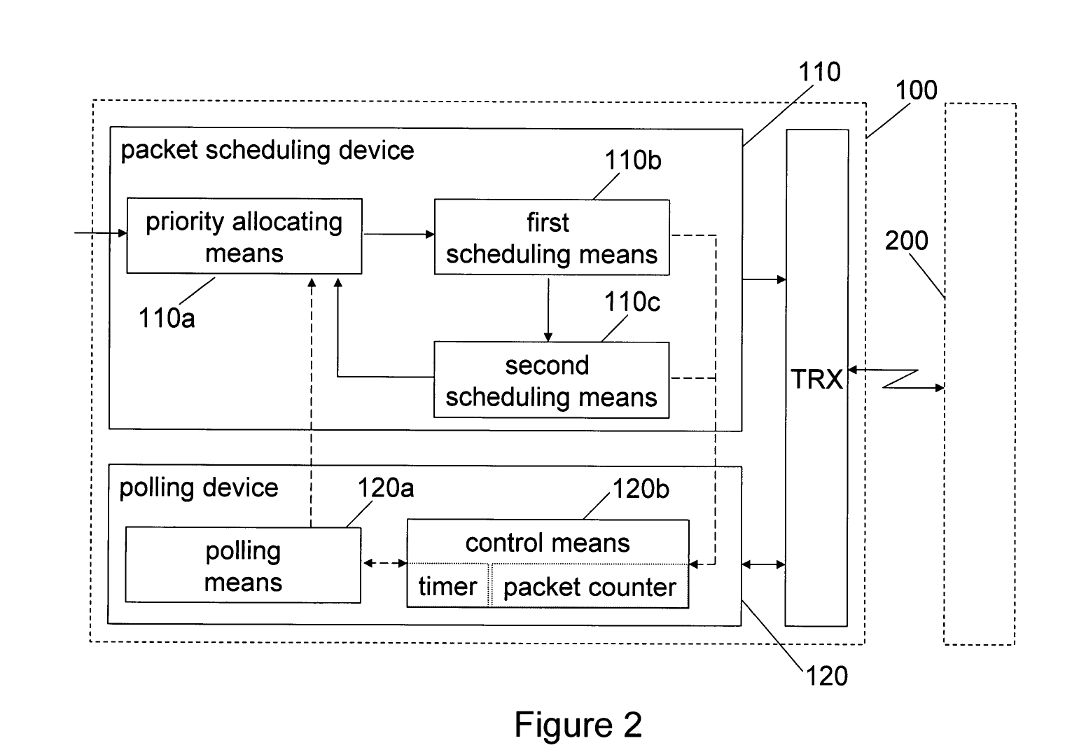

FIG. 2 depicts a block diagram of an apparatus according to one embodiment of the present invention. The shown apparatus is adapted to carry out the method described in connection with FIG. 1. For better comprehensibility, the names of the constituent blocks of the apparatus are thus adjusted to their respective functionalities.

The shown apparatus can be a part of a packet control unit PCU and thus be located at the network side, or can be a part of a terminal equipment and thus be located at the user side. In FIG. 2, the apparatus 100 according to the present invention is exemplified as a transmitting side of a mobile communication system. A receiving side of the mobile communication system is indicated by reference numeral 200. A packet transmission and/or retransmission between the transmitting side and the receiving side is indicated by a z-shaped and double-headed arrow between broken blocks 100 and 200.

The apparatus 100 of the present invention is adapted for controlling the packet transmission between the transmitting side and the receiving side in the mobile communication system. For this purpose, the apparatus 100 comprises at least one of a packet scheduling device 110 and a polling device 120. In FIG. 2, the apparatus is by way of example depicted to comprise both devices, however without limiting the present invention to such an arrangement.

In line with FIG. 1, only one input flow of blocks to the apparatus is depicted as an example. The incoming packets not yet transmitted are input to a priority allocating means 110a as well as blocks not yet acknowledged, which are fed back from a second scheduling device 110c which will be described below. The priority allocating means 110a is configured for allocating one of a plurality of priority levels to each input packet with packets not yet acknowledged being allocated lower priority levels than packets not yet transmitted.

The packets are then forwarded to first scheduling means 110b for scheduling of packets not yet transmitted in a manner described above. The second scheduling means 110c is configured for scheduling of packets not yet acknowledged. The packets which are still not acknowledged are fed back to the priority allocating means 110a.

According to embodiments of the present invention, the first scheduling means is configured to operate on the basis of a bucket round-robin scheme, and the second scheduling means is configured to operate on the basis of a round-robin scheme. The second scheduling means can further be configured to perform scheduling when the first scheduling means has completed scheduling of packets not yet transmitted.

The operation of the priority allocation means 110a is controlled by a polling means 120a belonging to the polling device 120. Namely, the priority allocating means 110a gets information about the status of each packet (after the operation of the first and the second scheduling means) from the polling means 120a.

The polling means 120a itself is controlled by a control means 120b which also forms a part of the polling device 120. The control means according to the present embodiment comprises a packet counter and a timer, and the control means is configured for maintaining a packet counter value PCV of the packet counter and a timer value TV of the timer. Accordingly, the control means is configured to change the packet counter value by a predetermined value when a packet is transmitted. The information about scheduled and/or transmitted packets originates from the first and the second scheduling means of the packet scheduling device 110 which is indicated in FIG. 2 by broken lines. The control means is also configured to reset the packet counter value and the timer value when the polling means performs polling of the receiving side to acknowledge transmitted packets.

The polling means preferably performs polling when a predefined packet counter value MP or a predefined timer value MPP has been reached.

According to one embodiment of the present invention, the polling device is configured for performing polling only for real time packets.

According to one implementation example, the packet scheduling device is a radio link control scheduler. Further, the apparatus 100 can be implemented as a part of a packet control unit PCU or as a part of a terminal equipment TE.

In accordance with the block diagram of FIG. 2, the apparatus 100 can in one embodiment further comprise a transceiver means (denoted by TRX). Such a transceiver means takes care of physical transmission and reception aspects related to the apparatus 100.

On the one hand, the transceiver means TRX obtains packets not yet transmitted and packets not yet acknowledged from the packet scheduling device 110. In correspondence with the scheduling of these packets, which has been effected as described above, the transceiver means TRX transmits and/or retransmits these packets to the receiving side 200.

On the other hand, the transceiver means TRX obtains polling requests from the polling means 120. The transceiver means TRX transmits these polling requests to the receiving side 200, and thereby physically effects the polling of the receiving side to acknowledge transmitted packets. Further, the transceiver means receives acknowledgments from the receiving side 200, and forwards these acknowledgments to the polling device 120 where they are processed further.

It is to be noted that the mentioned functional steps of the described method and the functional elements of the described arrangements as well as their constituents can be implemented by any known means, either in hardware and/or software, respectively, if they are only adapted to perform the respective effects and/or functions described above. For example, the polling means of the polling device can be implemented by any analogue or digital data processing unit, e.g. a microprocessor, a digital signal processor (DSP), or an application-specific integrated circuit (ASIC), which is adapted to poll a receiving side for acknowledgments for packet transmissions. In this case of a hardware implementation, the specific technology used is irrelevant to the present invention, such as e.g. MOS or bipolar transistors. In case of a software implementation, the implementation is independent from the specific programming language or environment used, such as e.g. C++, Assembler.

The mentioned parts and functions can also be realized in separate or individual functional blocks, or one or more of the mentioned parts and functions can be realized in common or jointly (independent from the way they are illustrated in any of the figures).

In summary, the present invention provides at least one of, or preferably a combination of, a prioritization of pending-ack blocks and a new polling strategy for real time temporary flow contexts, thereby achieving all the good properties of different retransmission styles for packets not yet acknowledged. That is, the capacity loss due to unnecessary retransmission of pending-ack blocks is avoided, and the favorable low delay effect of necessary retransmissions is maintained.

A first consideration of the described embodiments of the present invention can thus be considered as enhancements for a known bucket round-robin (BRR) scheduling algorithm for scheduling and polling of pending-ack blocks. These enhancements are primarily intended for being used at base station controllers of GPRS or EPGRS systems. Since the previous BRR algorithm comprises two phases, the present solution could be referred to as a scheduling phase III. A second consideration of the described embodiments of the present invention is a new polling strategy, which is to be employed only with real time temporary block flows TBFs.

The present invention improves scheduling and/or polling operations in high load conditions, providing not only better utilization of radio resources but also higher connection throughputs.

According to the present invention, there is provided a packet transmission control method and apparatus for packet transmissions between a transmitting side and a receiving side in a mobile communication system, wherein packets transmitted by the transmitting side are acknowledged by the receiving side, and unacknowledged packets are retransmitted to the receiving side, the method comprising at least one of the steps of: scheduling of packets, wherein packets not yet acknowledged are retransmitted only when no packets not yet transmitted to the receiving side are available at the transmitting side, and polling the receiving side to acknowledge transmitted packets on the basis of a packet counter value and a timer value.

Even though the invention is described above with reference to the examples according to the accompanying drawings, it is clear that the invention is not restricted thereto. Rather, it is apparent to those skilled in the art that the present invention can be modified in many ways without departing from the scope of the inventive idea as disclosed in the appended claims.

1. A packet transmission control method for packet transmissions between a transmitting side and a receiving side in a mobile communication system, wherein packets transmitted by the transmitting side are acknowledged by the receiving side, and unacknowledged packets are retransmitted to the receiving side, the method comprising at least one of the steps of:
scheduling of packets, wherein packets not yet acknowledged are retransmitted only when no packets not yet transmitted to the receiving side are available at the transmitting side; and
polling the receiving side to acknowledge transmitted packets based on a packet counter value and a timer value.

2. The method according to claim 1, wherein the step of scheduling further comprises a step of allocating one of a plurality of priority levels to each packet, wherein packets not yet acknowledged are allocated lower priority levels than packets not yet transmitted.

3. The method according to claim 2, wherein the step of scheduling further comprises the steps of:
scheduling of packets not yet transmitted; and
scheduling of packets not yet acknowledged, wherein
the step of scheduling of packets not yet transmitted is based on the priority levels allocated to these packets, such that the packets with higher priority levels are scheduled to be transmitted prior to the packets with lower priority levels.

4. The method according to claim 3, wherein the step of scheduling of packets not yet acknowledged is performed when the step of scheduling of packets not yet transmitted is completed.

5. The method according to claim 3, wherein the step of scheduling of packets not yet transmitted is performed based on a bucket round robin scheme.

6. The method according to claim 3, wherein the step of scheduling of packets not yet acknowledged is performed based on a round robin scheme.

7. The method according to claim 1, wherein the step of polling is performed when a predefined packet counter value or a predefined timer value is reached.

8. The method according to claim 7, wherein the packet counter value is changed by a predetermined value when a packet is transmitted.

9. The method according to claim 7, wherein the packet counter value and the timer value are reset to a predefined initial value when the step of polling is performed.

10. The method according to claim 7, wherein the predefined timer value is fixed.

11. The method according to claim 7, wherein the predefined timer value is dependent on at least one quality of service parameter associated with the packets to be transmitted.

12. The method according to claim 1, wherein the step of polling is performed only for real time packets.

13. The method according to claim 1, wherein the packets to be transmitted belong to a temporary block flow of a packet flow context.

14. An apparatus for controlling packet transmissions between a transmitting side and a receiving side in a mobile communication system, wherein packets transmitted by the transmitting side are acknowledged by the receiving side, and unacknowledged packets are retransmitted to the receiving side, the apparatus comprising at least one of:
a packet scheduling device for scheduling packets, wherein the packet scheduling device is configured such that packets not yet acknowledged are retransmitted only when no packets not yet transmitted to the receiving side are available at the transmitting side; and
a polling device for polling acknowledgements for packet transmissions, wherein the polling device is configured for polling the receiving side to acknowledge transmitted packets based on a packet counter value and a timer value.

15. The apparatus according to claim 14, wherein the packet scheduling device comprises:
priority allocating means for allocating one of a plurality of priority levels to each packet, wherein
the priority allocating means is configured for allocating to packets not yet acknowledged lower priority levels than to packets not yet transmitted.

16. The apparatus according to claim 14, wherein the packet scheduling device further comprises:
first scheduling means for scheduling packets not yet transmitted; and
second scheduling means for scheduling of packets not yet acknowledged, wherein
the first scheduling means is configured to operate based on the priority levels allocated to these packets such that the packets with higher priority levels are scheduled to be transmitted prior to the packets with lower priority levels.

17. The apparatus according to claim 16, wherein the second scheduling means is configured to perform scheduling when the first scheduling means has completed scheduling of packets not yet transmitted.

18. The apparatus according to claim 16, wherein the first scheduling means is configured to operate based on a bucket round robin scheme.

19. The apparatus according to claim 16, wherein the second scheduling means is configured to operate based on a round robin scheme.

20. The apparatus according to claim 14, wherein the packet scheduling device is a radio link control scheduler.

21. The apparatus according to claim 14, wherein the polling device is configured for performing polling when a predefined packet counter value or a predefined timer value is reached.

22. The apparatus according to claim 21, wherein the polling device comprises:
control means having a packet counter and a timer, wherein the control means is configured for maintaining the packet counter value and the timer value.

23. The apparatus according to claim 22, wherein the control means is configured to change the packet counter value by a predetermined value when a packet is transmitted.

24. The apparatus according to claim 22, wherein the control means is configured to reset the packet counter value and the timer value to a predefined initial value when polling is performed.

25. The apparatus according to claim 14, wherein the polling device is configured for performing polling only for real time packets.

26. The apparatus according to claim 14, further comprising:
transceiver means for performing transmission and reception between the transmitting side and the receiving side.

27. The apparatus according to claim 26, wherein the transceiver means is configured for transmitting packets not yet transmitted to the receiving side and for retransmitting packets not yet acknowledged to the receiving side, wherein the packets are received from the packet scheduling device.

28. The apparatus according to claim 26, wherein the transceiver means is configured for transmitting polling requests from the polling device to the receiving side, and for receiving acknowledgments from the receiving side and forwarding the acknowledgements to the polling device.

29. The apparatus according to claim 14, wherein the packets to be transmitted belong to a temporary block flow of a packet flow context.

30. The apparatus according to claim 14, the apparatus forming a part of a packet control unit.

31. The apparatus according to claim 14, the apparatus forming a part of a terminal equipment.

32. The apparatus according to claim 14, wherein the mobile communication system is a general packet radio service (GPRS) system.

33. The apparatus according to claim 14, wherein the mobile communication system is an enhanced general packet radio service (EGPRS) system.

34. The apparatus according to claim 14, wherein the mobile communication system is a global system for mobile communication (GSM) system.

35. An apparatus for controlling packet transmissions between a transmitting side and a receiving side in a mobile communication system, wherein packets transmitted by the transmitting side are acknowledged by the receiving side, and unacknowledged packets are retransmitted to the receiving side, the apparatus comprising at least one of:
a packet scheduling means for scheduling packets, wherein the packet scheduling means is configured such that packets not yet acknowledged are retransmitted only when no packets not yet transmitted to the receiving side are available at the transmitting side; and
a polling means for polling acknowledgements for packet transmissions, wherein the polling means is configured for polling the receiving side to acknowledge transmitted packets based on a packet counter value and a timer value.
